(19) United States
(12) Patent Application Publication
(10) Pub. No.: US 2002/0108829 A1
(43) Pub. Date: Aug. 15, 2002

(54) Means and method for modifying a motor vehicle

(76) Inventor: Michael S. Ward, Dallas, TX (US)

Correspondence Address: SHUGHART THOMSON & KILROY, P.C., 120 West 12th Street, Kansas City, MO, 64105, US

(21) Appl. No.: 09/781,841

(22) Filed: Feb. 12, 2001

(51) Int. Cl. F16D 47/06

(52) U.S. Cl. 192/3.21; 192/112

(57) ABSTRACT

A motor vehicle can be modified by interposing a connecting unit between two adjacent portions of the drive chain or the transmission system of the automobile. Transmission system modifying elements can be operatively placed in the transmission system or drive chain and any size and/or dimension differences between the modifying elements and the elements of the motor vehicle being modified are accommodated by the connecting unit whereby off-the-shelf elements can be combined with specialized motor vehicle components to modify that motor vehicle.

### BACKGROUND OF THE INVENTION

Nearly since its inception, the motor vehicle has been applied to a wide variety of uses and has been subjected to a wide diversity of requirements. For example, some motor vehicles are used for long distance travel while others are used for short trips. Some motor vehicles are used to haul heavy loads over relatively even terrain while others are used to haul loads over very uneven terrain. Still other motor vehicles are used “on road,” that is, on prepared surfaces, while other motor vehicles are used “off road.”

Still other motor vehicles are used for long, non-stop operation while other motor vehicles are used for stop and go driving. That is, long, non-stop operation may have the vehicle stop only for servicing and/or loading/unloading. On the other hand, some motor vehicles are driven only very short distances between stops, which can be frequent.

In the past, each type of motor vehicle has been designed for particular objectives associated with that motor vehicle. To this end, the motor vehicle and land vehicle arts contain a vast multitude of special designs for motor vehicles.

While effective for efficiently operating a motor vehicle, specially designing a motor vehicle for a particular objective has drawbacks. Principal among the drawbacks is the inability of one motor vehicle type to efficiently satisfy a variety of use requirements, especially if the objectives are widely divergent from each other. As technology and the economy expand and advance, more and more uses are being found for motor vehicles. In fact, new uses may even render obsolete objectives that were originally envisioned for a particular type of motor vehicle, while other uses may not have even been specifically envisioned by the motor vehicle designer. Thus, a motor vehicle may be designed and built for an objective that has been rendered obsolete.

More specifically, with the advance of modern society, in addition to a variety of objectives many motor vehicles that are designed for on-road use are also used off-road. Likewise, a motor vehicle designed and built for continuous use may be used for stop and go operation. However, because many motor vehicles are quite expensive, there is an incentive to use a single motor vehicle in a variety of uses and conditions, even if the uses and conditions are “non-design” uses and/or conditions.

Forcing a motor vehicle designed and built for one objective to achieve another objective or operate in non-design conditions may not make efficient use of the motor vehicle. In some instances, such non-design use of a motor vehicle can damage the vehicle or even be dangerous.

Therefore, there is a need for a means and a method for making a motor vehicle adaptable to a wider variety of objectives than previous motor vehicle designs.

Many motor vehicles, especially modem ones, can be very complex. In some cases, many of the motor vehicle parts are also interconnected to each other in complex ways. Accordingly, re-design and/or modification of modern motor vehicles can be complex and expensive.

Therefore, there is a need for a means and method for efficiently and economically adapting a motor vehicle to achieve an objective that differs from its design objective.

More specifically, all motor vehicles have some sort of transmission system for transferring power developed by the engine of the vehicle to the vehicle driving wheels. These transmission systems are often extremely complex and expensive to design and build. Due to these considerations, most transmission systems are carefully designed to meet defined criteria.

However, due to the above-discussed constraints, some motor vehicle transmissions are being used for non-design purposes with the concomitant drawbacks and problems. While some motor vehicle transmission systems may be designed to be versatile, these transmission systems can be so complex and unique as to be overly expensive and inefficient to service, sometimes even requiring expensive and specialized service personnel, parts and equipment.

Therefore, there is a need for a means and method for efficiently and effectively adapting a motor vehicle transmission system to meet criteria other than the criteria for which the transmission system was specifically designed and built.

However, some motor vehicles have space and size constraints which make it difficult to efficiently adapt the transmission system thereof from meeting a design objective to meeting a new objective. For example, a motor vehicle having a body sized and designed to operate off-road may have small spacings and closely dimensioned elements. As such, this type of motor vehicle may be very difficult to adapt to a new objective.

Therefore, the is a need for a means and method for efficiently adapting motor vehicles having tight spacings and dimensions to meet new objectives.

Moreover, in many motor vehicles, especially small ones, the sizes of the components of the engine thereof can be unique and difficult to match. Thus, if such an engine is to be modified to meet a new objective or use any elements used to effect the modification must be sized to match the elements of the existing motor vehicle. This can be expensive, especially if the motor vehicle has specially designed parts.

It would most efficient if a motor vehicle can be efficiently modified using standard, off-the-shelf, type items for the modification. However, as above discussed, this may be difficult, especially if the motor vehicle being modified uses specialized parts that may not have a size that can be readily matched using off-the-shelf type modifying parts.

Therefore, there is a need for a means and method for efficiently adapting motor vehicles having tight spacings and dimensions to meet new objectives and uses yet which can efficiently accommodate specialized part sizes on the motor vehicle being modified without requiring the parts being used to modify the motor vehicle to be specialized.

### SUMMARY OF THE INVENTION

These, and other objectives, are met by a means and a method which modifies a motor vehicle using off-the-shelf type parts. More particularly, the means and method of the present invention modifies the transmission system of a motor vehicle. Most specifically, the means and method of the present invention modifies a standard transmission system to operate in the manner of an automatic transmission system. That is, a clutch mechanism of the motor vehicle can be engaged and left engaged during stop and go driving.

This is achieved by placing a fluid coupling assembly between a flywheel assembly of a motor vehicle and a clutch mechanism of that motor vehicle. However, in the event that the dimensions of the interplaced fluid coupling assembly do not match those dimensions of the flywheel assembly, the present invention also contemplates the placement of a connecting unit between the fluid coupling assembly and the flywheel assembly. The connecting unit has one portion thereof connected to the flywheel assembly and has that one portion sized and dimensioned to match the size and dimensions of the flywheel assembly of the motor vehicle, and another portion thereof connected to the fluid coupling assembly and has that another portion sized and dimensioned to match the size and dimension of the fluid coupling assembly which is being used to modify the motor vehicle transmission system.

Using a fluid coupling assembly and a connecting unit permits any motor vehicle to be efficiently modified, or retrofitted, to have a standard transmission system operate in the manner of an automatic transmission system. That is, once the clutch assembly is engaged, it can remain engaged even when the motor vehicle is stopped but idling. Still further, using a connecting unit permits the retrofit fluid coupling assembly to be used in association with a variety of flywheel assemblies even if the dimensions of the flywheel assembly of the motor vehicle being modified do not match the dimensions of the fluid coupling assembly.

In this manner, a motor vehicle, even a specialized motor vehicle having specialized parts, can be efficiently modified to meet new objectives and uses, even using standard, off-the-shelf, elements to modify the motor vehicle.

### TECHNICAL FIELD OF THE INVENTION

The present invention relates to the general art of motor vehicles, and to the particular field of modifying or retrofitting motor vehicles, and specifically to the field of modifying a transmission system of a motor vehicle.

### OBJECTS AND ADVANTAGES OF THE INVENTION

It is a main object of the present invention to provide a means and a method for making a motor vehicle adaptable to a wider variety of objectives than previous motor vehicle designs.

It is another object of the present invention to provide a means and method for efficiently and economically adapting a motor vehicle to achieve an objective that differs from its design objective.

It is another object of the present invention to provide a means and method for efficiently and effectively adapting a motor vehicle transmission system to meet criteria other than the criteria for which the transmission system was specifically designed and built.

It is another object of the present invention to provide a means and method for efficiently adapting motor vehicles having tight spacings and dimensions to meet new objectives.

It is another object of the present invention to provide a means and method for efficiently adapting motor vehicles having tight spacings and dimensions to meet new objectives and uses yet which can efficiently accommodate specialized part sizes on the motor vehicle being modified without requiring the parts being used to modify the motor vehicle to be specialized.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 illustrates one type of motor vehicle that can be modified according to the teaching of the present invention.

FIG. 2 is a schematic of a transmission system that has been modified according to the teaching of the present invention.

FIG. 3 is a top view of a housing or protective casing used in the connecting unit used to adapt the transmission system of a motor vehicle according to the teaching of the present invention.

FIG. 4 is a side view of the housing shown in FIG. 3.

FIG. 5 is a bottom view of the housing of the connecting unit of the present invention.

FIG. 6 is an end view of the housing of the connecting unit of the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

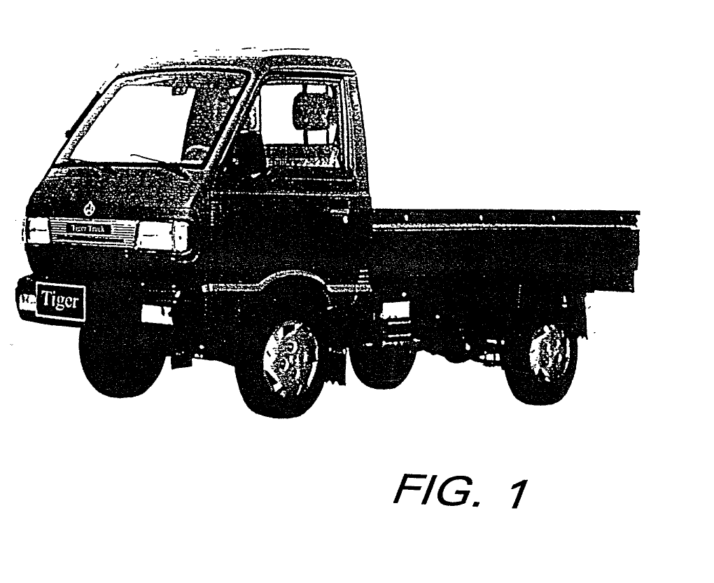

As discussed above, some motor vehicles are designed for one purpose, such as being driven “on road” for long distances, or the like. The motor vehicle M shown in FIG. 1 is illustratative of such vehicles. Motor vehicle M is a small truck having a standard transmission.

However, as was also discussed above, it would be useful if motor vehicles, such as motor vehicle M could be modified to meet new objectives, yet without undue expense and difficulty. However, as also mentioned above, motor vehicles such as truck M may have tight tolerances and transmission parts that may be special sizes that may be difficult to match. This makes retrofitting, or modifying, motor vehicles such as truck M difficult and expensive. This may preclude the use of off-the-shelf elements being used in modifying the motor vehicle to meet the new objectives. This may be especially true of a transmission system that has many complex parts that are interfit with each other and may have small tolerances and tight spacings.

The present invention comprises a means and a method for effecting the modification or retrofit of motor vehicles such as motor vehicle M in a manner that permits off-the-shelf elements to be used in the modification.

Broadly, the modification is effected by spacing the clutch mechanism of a transmission of the motor vehicle from the flywheel assembly of that motor vehicle and placing the parts required for the modification or adaptation in the gap formed between the flywheel assembly and the clutch mechanism. The modifying parts are then coupled to the appropriate portions of the existing transmission system, and a connecting unit is used to couple the transmission system elements and modifying parts together with the connecting unit being sized to connect to the appropriate parts of the transmission system. In this manner, even if off-the-shelf elements are used as the modifying parts and such off-the-shelf elements do not match the sizes of the transmission system being modified, the difference in sizes can be accommodated by variations in the housing of the connecting unit.

For example, if the flywheel assembly has one size and shape and the modifying parts have another size and shape, the connecting unit can have a size and shape at one end thereof that matches the size and shape of the flywheel assembly so the connecting unit will connect to the flywheel assembly in a secure manner at the one end of that connecting unit, with the connecting unit having another size and shape at the other end thereof that matches the size and shape of the clutch assembly of the motor vehicle so that end can be securely connected to the clutch mechanism. The connecting unit will thus have two sizes, which may differ from each other, that will permit the connecting unit to account for any differences in sizes and shapes between the modifying parts and the parts being modified. Even different shapes can be accommodated in this manner.

In this manner, many different parts can be used to modify a motor vehicle whereby a wide variety of adaptations can be effected. This will permit a motor vehicle to be modified in a wide variety of ways to meet a wide variety of objectives, even if the motor vehicle has not been originally designed to meet such new objectives.

The best mode for carrying out the present invention includes adapting a standard transmission in a motor vehicle, such as vehicle M to operate in the manner of an automatic transmission. That is, even though the transmission system is a standard transmission system, the vehicle engine can be left on and idling while the vehicle is stopped without specifically operating the clutch assembly of the motor vehicle.

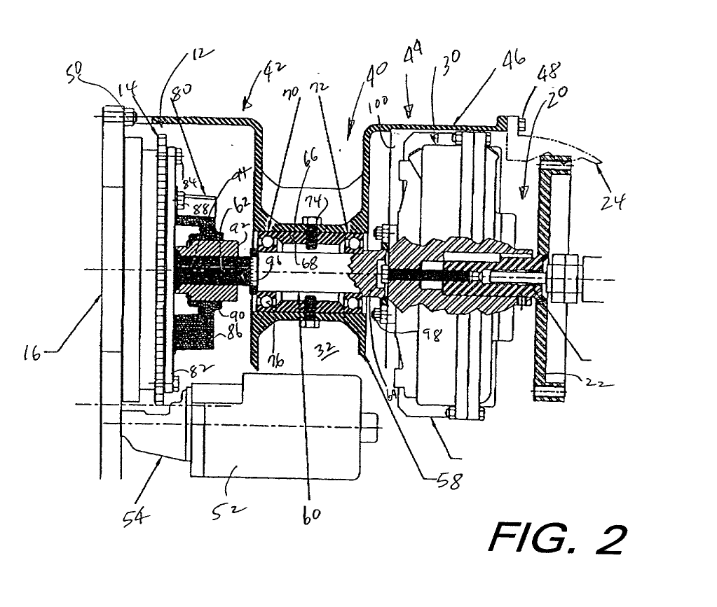

To this end, attention is directed to FIG. 2 in which a portion of a motor vehicle transmission system is illustrated. The invention provides a means and a method for modifying this transmission whereby a clutch mechanism can be engaged, and remain engaged, even during idling of the engine. Thus, the transmission system includes a flywheel assembly 12 having a flywheel 14 and mounted on an engine (not shown) by a mounting flange 16. Flywheel assembly 12 and the engine associated therewith operate in the manner usual to such assemblies, and thus will not be further discussed as those skilled in the motor vehicle art will understand how such an assembly will operate and function.

The motor vehicle transmission system further includes a clutch mechanism 20 having a clutch disc (not shown) adjacent to a pressure plate 22 and operatively connected to the remainder of the transmission system. The clutch assembly is known to those skilled in the art and thus will not be discussed. The remainder of the transmission system is usual to motor vehicles and thus will not be discussed. A transmission housing 24 is also indicated in FIG. 2.

The specific mode of the invention being described adapts a transmission system by including a fluid coupling assembly 30 between flywheel assembly 12 and clutch mechanism 20 so the clutch can remain engaged during engine idling. Fluid coupling assembly 30 transmits torque to the clutch according to the amount of torque applied to the fluid coupling. That is, until torque on the fluid coupling reaches a preset level, torque is not passed on to the clutch mechanism. In this manner, the engine can idle, but at a speed that produces torque that is below the preset level associated with the fluid coupling, and such torque will not be passed on to the remaining portions of the transmission system and the system will operate as though the clutch mechanism were disengaged, when, in fact, the clutch mechanism is still engaged. Those skilled in the art will understand how the fluid coupling assembly operates and thus the exact operation of the fluid coupling assembly will not be described.

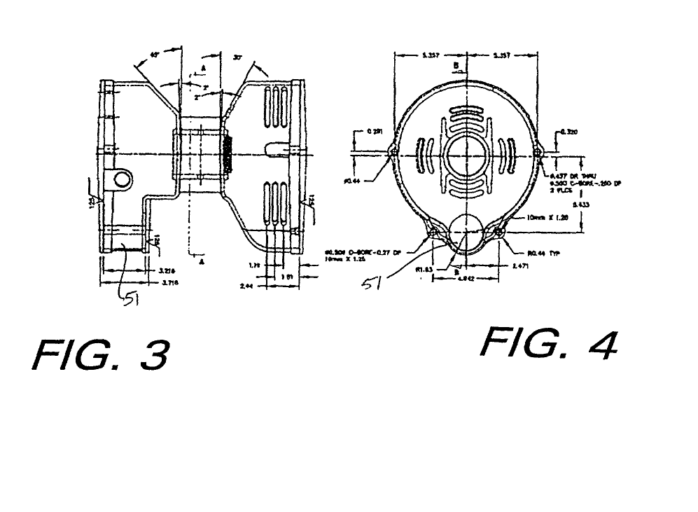

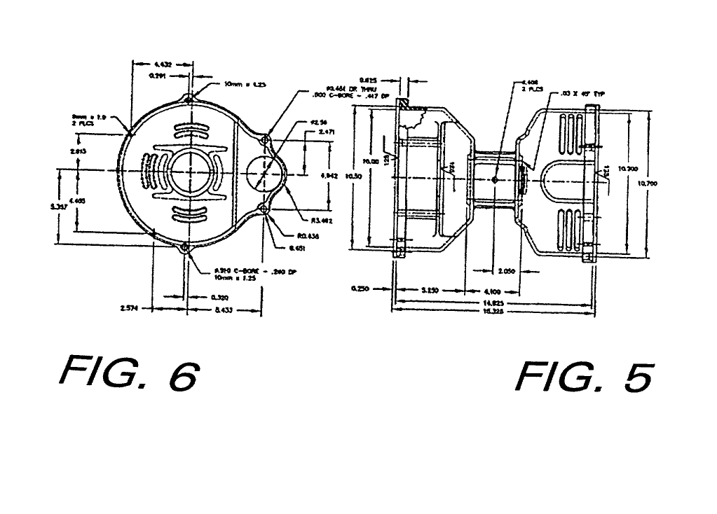

As above discussed, fluid coupling assembly 30 may have a size and shape that does not exactly match the size and shape of flywheel assembly 12. Accordingly, the present invention includes spacing flywheel assembly 12 from clutch mechanism 20 to define a gap 32 between the flywheel assembly and the clutch mechanism 20 and locating a connecting unit 40 in gap 32 and interposed between flywheel assembly 12 and clutch mechanism 20. More specifically, with regard 144 to the specific embodiment shown in FIGS. 2-4, but most specifically in FIG. 2, connecting unit 40 is located between flywheel 14 and fluid coupling assembly 30.

Connecting unit 40 includes one end 42 that is sized and shaped to match the size and shape associated with flywheel assembly 12 so end 42 of connecting unit 40 can be securely fixed to the flywheel assembly. Connecting unit 40 also includes a second end 44 that is sized and shaped to match the size and shape associated with clutch mechanism 20 and fluid coupling assembly 30 so end 44 of connecting unit 40 can be securely fixed to the transmission system adjacent to the clutch mechanism and/or the fluid coupling assembly. End 42 may have a size and shape that is different from the size and shape of end 44. In fact, such a difference in size would be expected since fluid coupling assembly 30 may be an off-the-shelf item and flywheel 14 may be specially sized for the particular motor vehicle associated therewith. Of course, the present invention also includes the situation where ends 42 and 44 are identical as well.

Connecting unit 40 includes a protective casing or housing 46 bolted adjacent to end 44 to transmission housing 24 by bolts such as bolt 48, and bolted adjacent to end 42 to flywheel assembly 12 by bolts such as bolt 50. As shown in FIGS. 2, 3 and 4, ends 42 and 44 are cylindrical in shape with end 42 being modified to include a portion 51 that accommodates starter 52 and starter motor 54. Cylindrical ends 42 and 44 are connected together by central portion 58 that is hourglass shaped to connect cylindrical ends 42 and 44 together even if those ends have sizes that differ from each other. Housing 46 can also be modified to accommodate other elements of the motor vehicle engine as will occur to those skilled in the art based on the teaching of the present disclosure.

Connecting unit 40 further includes the elements necessary to operatively drivingly couple flywheel assembly 12 to fluid coupling assembly 30 whereby power from the flywheel assembly is applied to the fluid coupling assembly via connecting unit 40. Connecting unit 40 can thus be viewed as a drive coupling. To this end, the specific mode of the invention shown in FIG. 2 includes a connecting shaft 60 fixed to flywheel 14 at one end 62 of connecting shaft 60 and fixed to fluid coupling assembly 30 at second end 64 of connecting shaft 60. Connecting shaft 60 is rotatable with flywheel 14 and transmits that rotation to fluid coupling assembly 30. Connecting shaft 60 is rotatably mounted in housing 58 by a ball bearing assembly 66 that includes a cage 68 with ball races 70 and 72. Cage 68 can be fixed to housing 58 by a bolt 74 and balls such as roller ball 76, are included in assembly 66.

Connecting shaft 60 is fixed to flywheel 14 by a unit 80 that includes a plate 82 fixed to flywheel 14 by bolts, such as bolt 84 and a cage 86 fixed to plate 82 as by bolts such as bolt 88 or the like. Cage 86 further includes a spider-like portion 90 that is attached to end 62 of shaft 60 in a manner that causes shaft end 62 to rotate with flywheel 14. One form of cage 86 includes block 92 fixed to spider-like portion 90 for rotation therewith and which has internal splines 94 engaged with external splines 96 on end 62 to couple end 62 to spider-like portion 90 so shaft 60 rotates with flywheel 14. The other end 64 of shaft 60 is fixed to fluid coupling assembly 30 by bolts 98 fixing shaft 60 to a plate 100 of the fluid coupling assembly so the appropriate portions of fluid coupling assembly 30 will rotate with shaft 60. Such rotation is applied to the appropriate portions of fluid coupling assembly so at torques associated with the motor vehicle engine as applied to shaft 60 by flywheel 14 that are below a preset value will not cause rotation of appropriate portions of clutch mechanism 20. In this manner, when engine torque or rotation as manifested by rotation of flywheel 14 are below a preset value, power will not be applied to driving wheels associated with the motor vehicle. As such, the motor vehicle will remain stationary even though the motor is operating and the clutch is engaged.

In this manner, motor vehicle M can include a standard transmission system but can be used for stop and go driving, such as would be associated with deliveries, meter readers, gardening grounds keeping, and the like.

The method of adapting or retrofitting a motor vehicle according to the present invention comprises: spacing flywheel assembly 12 of a motor vehicle from clutch mechanism 20 of the motor vehicle to define gap 32 between the flywheel assembly and the clutch mechanism; placing fluid coupling assembly 30 in the gap and operatively connecting the fluid coupling assembly to clutch mechanism 20. The method further includes placing connecting unit 40 in gap 32 and connecting the connecting unit to the flywheel assembly and to the clutch mechanism so rotation of flywheel 14 is transmitted to the fluid coupling assembly by the operative driving connection between the clutch mechanism and the flywheel assembly via the connecting unit. The method further includes matching the size of portion 42 of connecting unit 40 to the size of flywheel assembly 12 and matching the size of portion 44 of connecting unit 40 to the size of either clutch mechanism 20 or fluid coupling assembly 30 as appropriate.

It is to be understood that while certain forms of the present invention have been illustrated and described herein, it is not to be limited to the specific forms or arrangement of parts described and shown.

What is claimed and desired to be secured by Letters Patent is as follows:

1. An adapter for use in a motor vehicle transmission system comprising:
A) a flywheel assembly associated with a motor vehicle engine;
B) a clutch mechanism of a transmission system associated with the motor vehicle;
C) a fluid coupling assembly connected to said clutch mechanism and controlling operation of said transmission system;
D) said fluid coupling assembly being spaced apart from said flywheel assembly; and
E) a connecting unit connecting said flywheel assembly to said fluid coupling assembly, said connecting unit
(1) being located between said flywheel assembly and said fluid coupling assembly, and
(2) including:
(a) a housing connected at a first end thereof to said flywheel assembly and connected at a second end thereof to said fluid coupling assembly, and
(b) a connecting shaft in the housing of said connecting unit and being operatively coupled at one end thereof to said flywheel assembly for operation therewith and being operatively connected at another end thereof to said fluid coupling assembly so said fluid coupling assembly operated in association with the connecting shaft of said connecting unit and is driven by said flywheel assembly via said connecting unit.

2. The adapter defined in claim 1 wherein said connecting unit further includes a bearing assembly mounting the connecting shaft of said connecting unit on the housing of said connecting unit.

3. The adapter defined in claim 1 wherein the housing of said connecting unit includes a mounting portion which accommodates a starter unit of the motor vehicle engine.

4. The adapter defined in claim 1 wherein the housing of said connecting unit includes first and second cylindrical end portions adjacent to the first and second ends of said housing respectively.

5. The adapter defined in claim 4 wherein the housing of said connecting unit further includes an hourglass-shaped portion connecting the first and second cylindrical end portions together.

6. An adapter for retrofitting a motor vehicle transmission system comprising:
A) an engine flywheel assembly;
B) an engine clutch mechanism;
C) a fluid coupling assembly operatively connected to said clutch mechanism;
D) said fluid coupling assembly being spaced apart from said engine flywheel assembly and being operatively separated from said engine flywheel assembly; and
E) a connecting unit operatively connecting said engine flywheel assembly to said fluid coupling assembly whereby said flywheel assembly operates said fluid coupling assembly using said connecting unit.

7. An adapter for retrofitting a motor vehicle transmission system comprising:
A) a fluid coupling assembly connected to a clutch mechanism of a motor vehicle;
B) a connecting unit interposed between a flywheel assembly of the motor vehicle and said fluid coupling assembly;
C) said connecting unit including a connecting element operatively connecting the flywheel assembly to said fluid coupling assembly to drivingly connect said fluid coupling assembly to the flywheel assembly via said connecting unit.

8. An adapter for retrofitting a motor vehicle transmission system comprising:
A) a connecting unit interposed between a flywheel assembly of the motor vehicle and a clutch mechanism of the motor vehicle; and
B) said connecting unit including a connecting element operatively connecting the flywheel assembly to the clutch mechanism to drivingly connect the clutch mechanism to the flywheel assembly via said connecting unit.

9. A method of retrofitting a motor vehicle comprising:
A) providing a fluid coupling assembly;
B) spacing a flywheel assembly of a motor vehicle away from a clutch mechanism of the motor vehicle and defining a gap;
C) positioning a connecting unit in the gap;
D) connecting the connecting unit to the fluid coupling assembly and to the flywheel assembly; and
E) operatively driving the fluid coupling assembly from the flywheel assembly via the connecting unit.

10. A method of modifying a motor vehicle comprising:
A) spacing a flywheel assembly of a motor vehicle from a clutch mechanism of the motor vehicle to define a gap between the flywheel assembly and the clutch mechanism;
B) placing a connecting unit in the gap;
C) connecting the connecting unit to the flywheel assembly and to the clutch mechanism; and
D) operatively driving the clutch mechanism from the flywheel assembly via the connecting unit.

11. A method of retrofitting a motor vehicle comprising:
A) spacing a flywheel assembly of a motor vehicle from a clutch mechanism of the motor vehicle to define a gap between the flywheel assembly and the clutch mechanism;
B) placing a connecting unit in the gap;
C) connecting the connecting unit to the flywheel assembly and to the clutch mechanism;
D) operatively driving the clutch mechanism from the flywheel assembly via the connecting unit;
E) matching the size of one portion of the connecting unit to the size of the flywheel assembly; and
F) matching the size of another portion of the connecting unit to the size of the clutch mechanism.

12. A protective casing for use with a motor vehicle transmission in which a clutch mechanism is driven by a flywheel assembly comprising:
A) a housing;
B) one portion of said housing being sized to match the size of a clutch mechanism of a motor vehicle;
C) another portion of said housing being sized to match the size of the flywheel assembly; and
D) said housing being positioned between the flywheel assembly and the clutch mechanism.

13. A drive coupling for a motor vehicle transmission comprising:
A) a first connecting portion operatively connected to a flywheel assembly of a motor vehicle engine to be operated by the flywheel assembly;
B) a second connecting portion operatively connected to a clutch mechanism to drive the clutch mechanism in response to operation of said first connecting portion;
C) said first and second connecting portions being spaced apart from each other and located between the flywheel assembly and the clutch mechanism.

14. The protective casing defined in claim 12 wherein the size of said one portion is different from the size of said another portion.

15. The drive coupling defined in claim 13 wherein said first connecting portion has a size that is different from the size of said second connecting portion.

16. The method defined in claim 11 further including a steps of connecting the one portion of the connecting unit to the flywheel assembly; connecting the another portion of the connecting unit to the clutch mechanism; and sizing the one portion of the connecting unit connected to the flywheel assembly to be different from the size of the another portion of the connecting unit connected to the clutch mechanism.

17. The adapter defined in claim 6 wherein said connecting unit includes a first end sized to match the size of said flywheel assembly and a second end sized to match the size of said fluid coupling assembly with the size of said first end being different from the size of said second end.

18. The adapter defined in claim 1 further including a cage unit connecting the one end of the connecting shaft of said connecting unit to said flywheel assembly so that the one end of the connecting shaft of said connecting unit rotates with a flywheel of said flywheel assembly.

19. The adapter defined in claim 18 wherein the one end of the connecting shaft of said connecting unit includes splines and said cage unit includes slots that interfit with said splines.
